(19) United States
(12) Patent Application Publication
(10) Pub. No.: US 2024/0340661 A1
(43) Pub. Date: Oct. 10, 2024

(54) TRANSMITTING NODE, RECEIVING NODE AND METHODS PERFORMED THEREIN

(71) Applicant: Telefonaktiebolaget LM Ericsson (publ), Stockholm (SE)

(72) Inventors: Vicknesan AYADURAI, Sollentuna (SE); Daniel CEDERHOLM, Sollentuna (SE); Peter DE BRUIN, Gammelstad (SE); Junaid ANSARI, Aachen (DE); Jonas KRONANDER, Knivsta (SE)

(21) Appl. No.: 18/573,712

(22) PCT Filed: Jun. 21, 2022
(86) PCT No.: PCT/SE2022/050615

§ 371 Date: Dec. 22, 2023

Related U.S. Application Data
(60) Provisional application No. 63/213,781, filed on Jun. 23, 2021.

(51) Int. Cl. H04W 24/02; H04W 28/02; H04W 48/18

(52) U.S. Cl. CPC H04W 24/02; H04W 28/0268; H04W 48/18

(57) ABSTRACT

Embodiments herein may for example disclose a method performed by a transmitting node, such as a first network node, for handling communication between a control node and a device controlled by the control node. The control node and the device are configured for wired communication. The transmitting node receives one or more packets in a first format from the control node or the device over a wired connection. The transmitting node processes the one or more packets into a second format for communication over a wireless connection by using a transmission process for processing the one or more packets into the second format; and transmits the one or more packets in the second format over the wireless connection towards the device or the control node.

### TECHNICAL FIELD

Embodiments herein relate to a transmitting node, a receiving node, and methods performed therein for communication. Furthermore, a computer program and a computer readable storage medium are also provided herein. In particular, embodiments herein relate to efficiently control automated machinery.

### BACKGROUND

In a typical wireless communications network, user equipment (UE), also known as wireless communication devices, mobile stations, stations (STA) and/or wireless devices, communicate via a Radio Access Network (RAN) with one or more core networks (CN). The RAN covers a geographical area which is divided into service areas or cell areas, with each service area or cell area being served by radio network node such as an access node e.g., a Wi-Fi access point or a radio base station (RBS), which in some networks may also be called, for example, a NodeB, a gNodeB, or an eNodeB. The service area or cell area is a geographical area where radio coverage is provided by the radio network node. The radio network node operates on radio frequencies to communicate over an air interface with the UEs within range of the radio network node.

The radio network node communicates over a downlink (DL) to the UE and the UE communicates over an uplink (UL) to the radio network node.

In today's factories various machinery and other devices are computer-controlled and operate in a distributed fashion. Due to strict demands in terms of reliability, robustness, and timings, and no suitable wireless technologies available, communication between these different pieces of equipment is done over wired cables, which typically carry Ethernet-type traffic, a tried and tested standard which has been in wide use in industry and office environments for decades.

There are numerous Industrial Ethernet based protocols currently in place in today's manufacturing environment such as EtherCAT, PROFINET, PROFIBUS, ComNal, and the newer IEEE802.1 Time Sensitive Networking (TSN) standards, to name a few. Some of these are standardized specifications while others, proprietary. Collectively, these protocols run tens of thousands of pieces of equipment in factories around the globe.

As the manufacturing process scales up, additional machineries are added to the factory floor and more communications links are introduced in the form of new cables between these nodes, making it possible to scale production virtually infinitely. However, the benefits from the simplicity of laying new cables come at a cost. The cables typically become part of the fixtures and the possibility of physically moving machinery around to change the production process becomes a tedious and costly exercise. Maintaining the cabling requires documentation and tracking, conduits, cable-trays, and other supporting infrastructure also needs to be added and managed. The possibility for a flexible manufacturing process becomes cumbersome and rearrangement of production lines is inhibited, while manageability of these wired industrial networks become increasingly challenging.

Another common trend is an adaptation to the network architecture and topology in the manufacturing environment. There is now an increasing interest to centralize more and more functions, e.g., into a local edge cloud or even to an off-site data center. This could lead to cheaper computing resources in the form of Common Off-The-Shelf (COTS) hardware instead of dedicated nodes as well as improved coordination between nodes and sensors since more information is available at the same place. Centralization of network functions could then lead to that functions that used to run on the same node, or on nearby nodes interconnected by short cables, now are separated and thus opening up new interfaces that might need to be interconnected over larger distances.

A wireless solution to replace these Ethernet cables would be a welcomed salvation. Newer generation cellular networks, such as 5G, providing ultra-reliable low-latency communications (URLLC) capabilities, hold the promise of providing a wireless alternative to the Ethernet cables used in the manufacturing landscape. However, the wireless medium is a shared commodity in scarce supply. In order to fulfil the timing-sensitive nature of machine automation requirements as described above, communication protocols need to be efficiently and optimally designed for wireless communication and implemented, to enable completely replacing copper Ethernet cables with a wireless communication system.

### SUMMARY

An object of embodiments herein is to provide a mechanism for enabling wireless communication in a communication network or system configured for wired communication, such as a factory automation system.

According to an aspect the object is achieved by providing a method performed by a transmitting node for handling communication between a control node and a device controlled by the control node, wherein the control node and the device are configured for wired communication. The transmitting node receives one or more packets in a first format from the control node or the device over a wired connection. The transmitting node further processes the one or more packets into a second format for communication over a wireless connection. The processing comprises using a transmission process for processing the one or more packets into the second format. The transmitting node then transmits the one or more packets in the second format over the wireless connection towards the device or the control node.

According to another aspect the object is achieved by providing a method performed by a receiving node for handling communication between a control node and a device controlled by the control node, wherein the control node and the device are configured for wired communication. The receiving node receives one or more packets in a second format transmitted over a wireless connection from a transmitting node, wherein the transmitting node is connected by wire to the control node or the device. The receiving node processes the one or more packets into a first format for communication over a wired connection. The processing comprises using a reception process for processing the one or more packets into the first format. The receiving node then transmits the one or more packets in the first format over the wired connection towards the device or the control node.

It is furthermore provided herein a computer program comprising instructions, which, when executed on at least one processor, cause the at least one processor to carry out any of the methods herein, as performed by the transmitting node and the receiving node, respectively. It is additionally provided herein a computer-readable storage medium, having stored thereon a computer program comprising instructions which, when executed on at least one processor, cause the at least one processor to carry out any of the methods herein, as performed by the transmitting node and the receiving node, respectively.

According to yet another aspect the object is achieved, according to embodiments herein, by providing a transmitting node for handling communication between a control node and a device controlled by the control node, wherein the control node and the device are configured for wired communication. The transmitting node is configured to receive one or more packets in a first format from the control node or the device over a wired connection. The transmitting node is further configured to process the one or more packets into a second format for communication over a wireless connection by using a transmission process for processing the one or more packets into the second format. The transmitting node is also configured to transmit the one or more packets in the second format over the wireless connection towards the device or the control node.

According to still another aspect the object is achieved, according to embodiments herein, by providing a receiving node for handling communication between a control node and a device controlled by the control node, wherein the control node and the device are configured for wired communication. The receiving node is configured to receive one or more packets in a second format transmitted over a wireless connection from a transmitting node, wherein the transmitting node is connected by wire to the control node or the device. The receiving node is further configured to process the one or more packets into a first format for communication over a wired connection by using a reception process for processing the one or more packets into the first format; and to transmit the one or more packets in the first format over the wired connection towards the device or the control node.

Embodiments herein modify traffic in the first format, which may be considered “sub-optimal” factory automation traffic for wireless connections, into a more efficient form, i.e., the second format, for network transmission over a wireless connection. Apart from the benefit of making better use of the wireless spectrum, an advantage of embodiments herein is the possibility of legacy still-in-operation factory automation equipment, i.e., the device and the control node configured for wired communication, currently in production systems all over the world, to migrate to a wireless communication and be a part of a factory-of-the-future. Thus, embodiments herein enable wireless communication in a communication network or system for automated machinery.

### BRIEF DESCRIPTION OF THE DRAWINGS

Embodiments will now be described in more detail in relation to the enclosed drawings, in which:

FIG. 1 is a schematic overview depicting a communication network according to embodiments herein;

FIG. 2 is a combined flowchart and signalling scheme according to embodiments herein;

FIG. 3 is a combined flowchart and signalling scheme according to embodiments herein;

FIG. 4 shows a schematic flowchart depicting a method performed by a transmitting node according to embodiments herein;

FIG. 5 shows a schematic flowchart depicting a method performed by a receiving node according to embodiments herein;

FIG. 6 is a schematic overview depicting a communication network according to embodiments herein;

FIG. 7 is a schematic overview depicting a communication network according to some embodiments herein;

FIG. 8 is a schematic overview depicting a communication network according to some embodiments herein;

FIG. 9 is a block diagram depicting a transmitting node according to some embodiments herein;

FIG. 10 is a schematic overview depicting a communication network according to some embodiments herein;

FIG. 11 is a block diagram depicting a transmitting node according to embodiments herein;

FIG. 12 is a block diagram depicting a receiving node according to embodiments herein;′

FIG. 13 schematically illustrates a telecommunication network connected via an intermediate network to a host computer;

FIG. 14 is a generalized block diagram of a host computer communicating via a base station with a user equipment over a partially wireless connection; and

FIGS. 15-18 are flowcharts illustrating methods implemented in a communication system including a host computer, a base station and a user equipment.

### DETAILED DESCRIPTION

Compared to wireless communications, wired Ethernet communication links can be considered to effectively provide almost:
zero latency
zero losses, and
infinite bandwidth.

As a result of the above the wired communication links were rarely a constraint on the design of factory automation systems and the resulting communications protocols have been built without much thought and planning in terms of the capacity bottlenecks. This resulted in systems which are unnecessarily “chatty”, e.g., with verbose signaling, transporting unused or redundant information, e.g., sending zeros or padding bits when there is no information that needs sending, transporting static information frequently and having zero tolerance to information arriving late, or information being lost along the way.

The requirements based on these unrealistic assumptions are unlikely to be met by wireless systems operating on a shared medium subjected to external interferences and limitations of natural physics.

Newer factory automation systems which will be created to operate over wireless communications links may be designed more efficiently and take into account the constraints and limitations of the wireless medium.

However, there exists a vast amount of legacy factory automation systems with devices configured for wired communication all around the world which, while will all gain from the benefits of replacing their wired Ethernet connections with a wireless communication link instead, are unable to do so simply because of the sub-optimal design of their legacy communications protocols for wired connections.

This limitation marginalizes these legacy systems and leaves them literally held back by the wired copper cables they use to communicate with, as factory automation systems move forward.

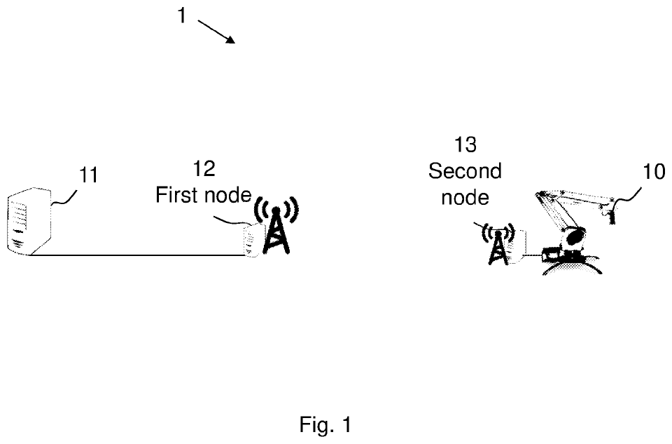

Embodiments herein relate to communication networks in general and FIG. 1 shows a schematic overview depicting a communication network 1 according to embodiments herein. In the communication network 1, devices such as a device 10 are configured for wired communication with a control device 11. The device 10 may comprise a robotic device, a machinery, a factory equipment, a controlled device such as a mobile station, a mobile robot, a piece of machinery, a controlled mobile device. It should be understood by those skilled in the art that “device” is a non-limiting term which means any terminal, wireless communication terminal, internet of things (IoT) capable device, Machine Type Communication (MTC) device, Device to Device (D2D) terminal, or node e.g. smart phone, laptop, mobile phone, sensor, relay, mobile tablets to be controlled within the communication network 1.

The control node 11 may be any controlling device such as a computer, a controlling server, an operated control pad, a central communication node or similar.

According to embodiments herein a pair of nodes, i.e. a first node 12 and a second node 13, are implemented into the communication network for enabling wireless communication over a wireless connection between the device 10 and the control node 11. The pair of nodes are configured to process packets between the control node 11 and the device 10 to enable the wireless communication between the control node 11 and the device 10. The node transmitting one or more packets over the wireless connection is referred to as a transmitting node 150 and the node receiving the one or more packets over the wireless connection is referred to as a receiving node 160. Thus, the transmitting node 150 may be the first node 12 when flow of packets is travelling towards the device over the wireless connection, and the receiving node 160 may thus be the second node 13 receiving the packets coming from the control node 11. Conversely, the transmitting node 150 may be the second node 13 when flow of packets is traveling towards the control node 11 over the wireless connection, and the receiving node 160 may thus be the first node 12 receiving the packets coming from the device 10.

Factory automation traffic, while having very tight timing requirements, is also highly consistent and predictable. Unlike familiar devices like computers and smartphones which run a myriad of different applications, each with its own traffic pattern and characteristics, factory equipment or machinery, being examples of a device, typically runs a single “application” which generates a single type of traffic. The factory equipment traffic will usually travel between the same source and destination devices, have the same packet sizes, the same periodicity, etc., i.e., the factory equipment traffic will always maintain the same pattern.

This predictable traffic pattern runs reliably over wired connections today. However, when switching over to wireless connections, less efficient factory automation communication protocols, particularly the older legacy ones, may not work as reliably. Hence, designing a wireless solution supporting these wired protocols may be highly inefficient and preventively expensive to implement.

When moving to a wireless scenario, using, for example, a cellular system, embodiments herein propose placing a pair of entities, i.e. the transmitting node 150 and the receiving node 160, between source and destination factory automation devices, along the communication path. The transmitting node 150 may then alter the traffic stream of packets as it leaves the origin by using a transmission process, before the packets enter the more sensitive wireless region of the path. Subsequently, the receiving node 160 restores the information to its original format, i.e. a first format, before reaching the destination device 10 or control node 11, depending on direction of the communication.

It is herein disclosed that in order to provide a reliable communication between the device 10 and the control node 11, the transmitting node 150 receives one or more packets in a first format from the control node 11 or the device 10 over a wired connection. First format may also be referred to as a wired format or a format for wired communication.

The transmitting node 150 processes, e.g. alters/changes, the one or more packets into a second format for communication over the wireless connection by using a transmission (TX) process for processing the one or more packets into the second format. The transmission process may also be referred to as transformation process or a first process. The transmission process may be selected from a table comprising one or more transmission processes configured at the transmitting node 150 based on an identity of the packet indicating flow identity. The transmitting node 150 then transmits the one or more packets in the second format over the wireless connection towards the device 10 or the control node 11. The transmitting node 150 may further tag the one or more packets with an indication indicating process used on the one or more packets. Second format may also be referred to as a wireless format or a format for wireless communication.

At the receiving side, the receiving node 160 receives the one or more packets in the second format transmitted over the wireless connection from the transmitting node 150. The receiving node 160 then processes the one or more packets into the first format for communication over the wired connection using a reception (RX) process for processing the one or more packets into the first format. The reception process may also be referred to as detransformation process or second process. The reception process may be selected from a table comprising one or more reception processes configured at the receiving node 160 based on the indication tagged to the one or more packets and/or the flow identity of the one or more packets. The receiving node 160 then transmits the one or more packets in the first format over the wired connection towards the device 10 or the control node 11.

Thus, embodiments herein enable for example factory automation communications systems comprising one or more devices such as the device 10 that are inefficiently designed for wireless transport, to communicate efficiently over wireless connections. The pair of nodes, i.e. the transmitting node 150 and the receiving node 160, are traffic-shaping entities capable of “massaging” an ongoing factory automation traffic stream or flow, which may consist of a legacy and/or proprietary communications protocol, in real-time into a more optimized form, i.e. the second format, for increased efficient transport over a wireless, or possibly even wired, communication system. Embodiments herein leverage on the predictability and static nature of the data traffic and exploits these characteristics by “massaging” the traffic flow on-the-fly to improve overall performance.

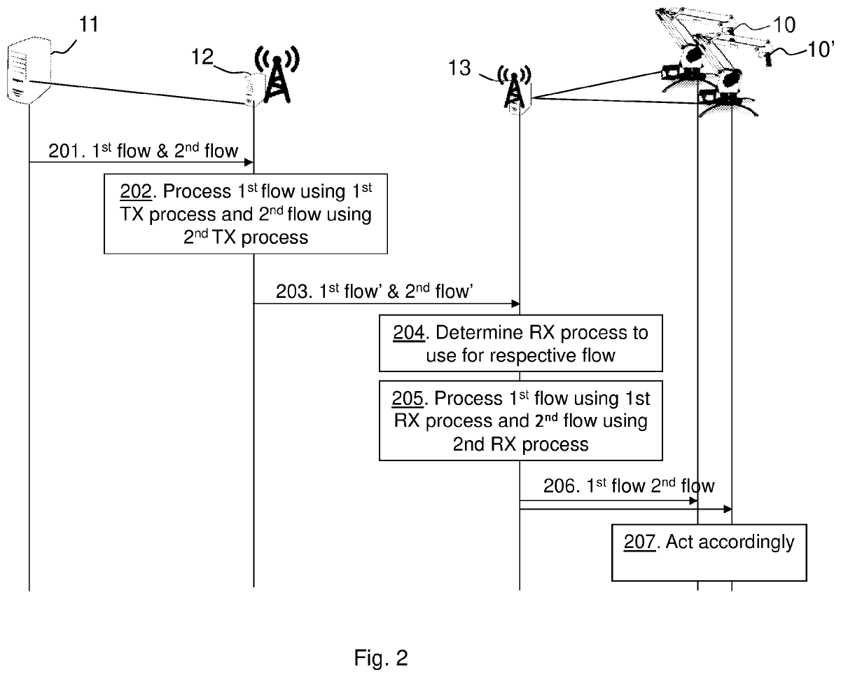

FIG. 2 is a combined flowchart and signalling scheme according to some embodiments herein. The first node 12 is herein an example of the transmitting node 150, and the second node 13 is herein an example of the receiving node 160.

Action 201. The control node transmits a first flow of packets for managing movement of the device 10. The packets of the first flow may be marked with a first flow identity (ID) indicating that information in the packets is movement information. Furthermore, the control node 11 may transmit a second flow of packets for providing operational instructions to the device 10 or as illustrated to another device 10′. The packets of the second flow may be marked with a second flow ID indicating that information in the packets is relating to operational instructions. The packets of the first flow and the packets of the second flow are of a respective first format.

Action 202. The first node 12 receives the first flow of packets and the second flow of packers over the wired connection between the control node 11 and the first node 12. The first node 12 then processes the packets of the first flow using a first transmission process selected based on the first flow ID. For example, the first node 12 may be configured with a table mapping the first flow ID to a compressing process, thus, compressing the packets. The first node 12 may further process the packets of the second flow using a second transmission process selected based on the second flow ID. For example, the table may map the second flow ID to a combined process, for example, encrypting and compressing the packets. The first node 12 may further tag the packets of each flow with an indication such as a value indicating the process used on respective flow of packets. For example, the packets of the first flow may be tagged with a first tag value and the packets of the second flow may be tagged with a second tag value.

Action 203. The first node 12 then transmits the processed first flow of packets and the processed second flow of packets over the wireless connection, wherein the processed first flow of packets and the processed second flow of packets are of a respective second format.

Action 204. The second node 13 receives respective flow of packets and determines reception process to process respective flow of packets.

Action 205. The second node 13 processes the packets of the first flow, into the first format, using a first reception process selected based on the first tag value. For example, the second node 13 may be configured with a table mapping the first tag value to a decompressing process, thus, decompressing the packets. The second node may further process the packets of the second flow, into the first format, using a second reception process selected based on the second tag value. For example, the table may map the second tag value to a combined process, for example, decrypting and decompressing the packets.

Action 206. The second node then transmits the first flow of packet to the device 10 over the wired connection and the second flow of packets to a second device 10′ over the wired connection.

Action 207. The device 10 may act according to the data in the packets of the first flow and the second device 10′ may act according to the data in the packets of the second flow.

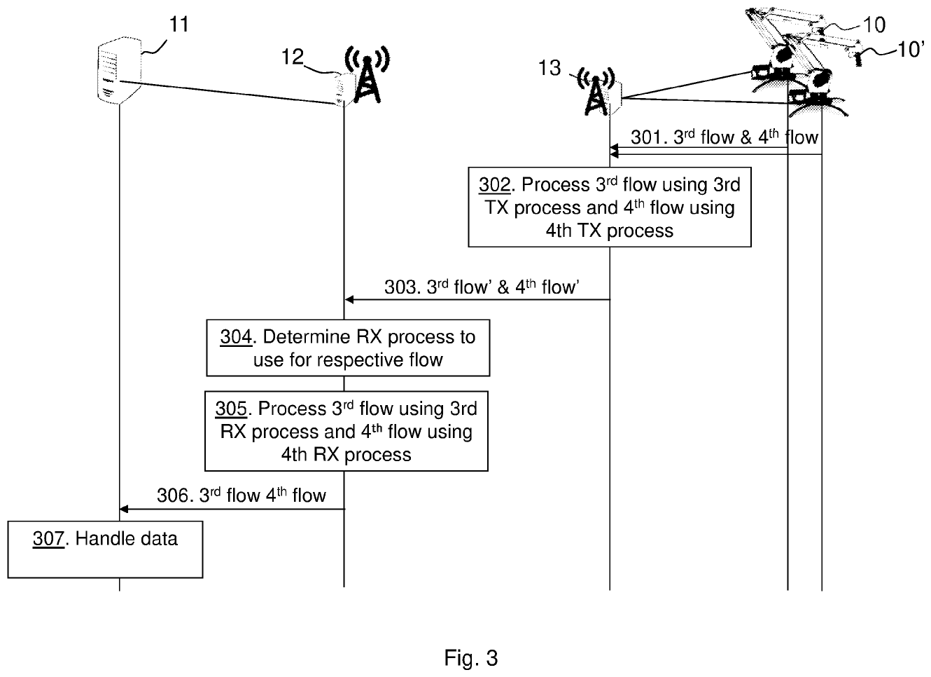

FIG. 3 is a combined flowchart and signalling scheme according to some embodiments herein. The second node 13 is herein an example of the transmitting node 150 and the first node 12 is herein an example of the receiving node 160.

Action 301. The device 10 transmits a third flow of packets regarding feedback information to the control node 11. The packets of the third flow may be marked with a third flow ID indicating that information in the packets is feedback information. Furthermore, the second device 10′ may transmit a fourth flow of packets for providing sensor data to the control node 11. The packets of the fourth flow may be marked with a fourth flow ID indicating that information in the packets is relating to operational instructions. The packets of the third flow and the packets of the second flow are of a respective first format.

Action 302. The second node 13 receives the third flow of packets and the fourth flow of packers over the wired connection between the second node 13 and the device 10 and the second device 10′. The second node 13 then processes the packets of the third flow using a third transmission process selected based on the third flow ID. For example, the second node 13 may be configured with a table mapping the third flow ID to a compressing process, thus, compressing the packets. The second node 13 may further process the packets of the fourth flow using a fourth transmission process selected based on the fourth flow ID. For example, the table may map the fourth flow ID to a combined process, for example, encrypting and compressing the packets of the fourth flow. The second node 13 may further tag the packets of each flow with an indication such as a value indicating the process used on respective flow of packets. For example, the packets of the third flow may be tagged with a third tag value and the packets of the fourth flow may be tagged with a fourth tag value.

Action 303. The second node 13 then transmits the processed third flow of packets and the processed fourth flow of packets over the wireless connection, wherein the processed third flow of packets and the processed fourth flow of packets are of a respective second format.

Action 304. The first node 12 receives respective flow of packets and determines reception process to process respective flow of packets.

Action 305. The first node 12 processes the packets of the third flow, into the first format, using a third reception process selected based on the third tag value. For example, the first node 12 may be configured with a table mapping the third tag value to a decompressing process, thus, decompressing the packets. The first node 12 may further process the packets of the fourth flow, into the first format, using a fourth reception process selected based on the fourth tag value. For example, the table may map the fourth tag value to a combined process, for example, decrypting and decompressing the packets.

Action 306. The first node 12 then transmits the third flow of packets and the fourth flow of packets to the control node 11 over the wired connection.

Action 307. The control node may then receive and handle data in the packets of the third flow and fourth flow, respectively.

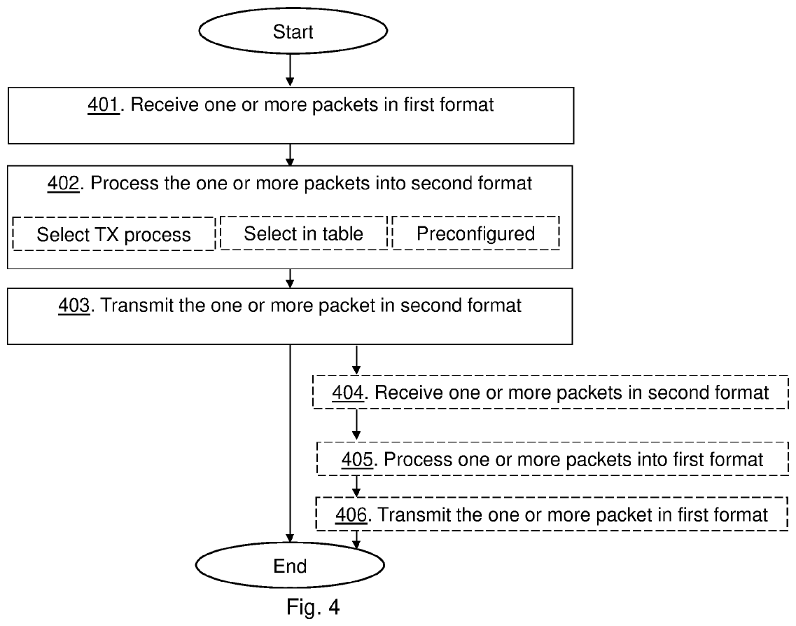

The method actions performed by the transmitting node 150, such as the first node 12 or the second node 13, for handling communication between the control node and the device controlled by the control node according to embodiments herein will now be described with reference to a flowchart depicted in FIG. 4. The control node 11 and the device 10 are configured for wired communication in the communication network 1. The transmitting node 150 may be a standalone node, i.e. a separated node, between a radio access node and the control node 11, or the device 10 (connected over a wire). The transmitting node 150 may additionally or alternatively be a unit collocated with the radio access node, or the control node 11 or the device 10. Optional actions are marked with dashed boxes and the actions may be taken in any suitable order.

Action 401. The transmitting node 150 receives one or more packets in the first format from the control node 11 or the device 10 over the wired connection.

Action 402. The transmitting node 150 processes the one or more packets into the second format for communication over the wireless connection, by using a transmission process for processing the one or more packets into the second format. For example, the transmitting node 150 may select the transmission process out of a number of transmission processes configured at the transmitting node 150. The one or more packets may belong to a flow of packets and may comprise a flow identity identifying the flow, and wherein the transmission process used for processing the one or more packets is selected based on the flow identity. Hence, the one or more packets may be assigned or associated with the flow identity included in each packet. The transmitting node may dynamically select different or respective transmission processes for different flows of packets between the control node 11 and the device 10. Thus, different transmission processes may and may not be used for different flows, and for each of the different flows of packets, a respective transmission process may be selected. The selection may be done dynamically, which means that it is performed per flow and a time slot. The transmission process used for processing the one or more packets may be selected from a preconfigured table, a first table, associating (different or respective) transmission processes with different flow identities between the control node and the device. It should also be noted that the transmission process used for processing the one or more packets may be preconfigured to be used at the transmitting node. For example, the transmitting node 150 may preconfigured to compress all packets. The transmitting node 150 may further process the one or more packets by tagging, for example one or more of, the one or more packets with an indication indicating the transmission process used for processing the one or more packets.

. For example, a value or an index may indicate what process has been used on the one or more packets. Thus, this indication allows identification at the reception side of which process has been used on a packet at the transmission side. The transmission process used for processing the one or more packets may be one or more of the following: compressing the one or more packets, encrypting the one or more packets, and/or adding a number of repetitive transmissions of the one or more packets. It should be noted that the transmission process may comprise tagging the packet with the indication, for example, indicating that a time jitter buffer should be used at the reception side. The transmitting node 150 may thus tag one or more packets wherein the tag indicates that the one or more packets may be time differentiated or received with different delay due to the wireless communication and hence a time aligning process may be required at the reception side also referred to as using a jitter buffer. This part refers to that the wireless system may introduce jitter, which is an unequal spacing between the packets at the receiver side. The point is that the time between two subsequent packets at the receiver side is not the same for every pair of subsequent packets. To fix this the time aligning process may be performed, which may be referred to as de-jittering at the receiver side.

Action 403. The transmitting node 150 transmits the one or more packets in the second format over the wireless connection towards the device 10 or the control node 11.

Since the procedure may be reciprocal, with the FATSO entities working in a similar manner on the opposite direction traffic; the transmitting node 150 may also perform the following actions.

Action 404. The transmitting node 150 may receive one or more packets in the second format transmitted over the wireless connection from the receiving node 160. The receiving node is connected by wire to the control node or the device.

Action 405. The transmitting node 150 may process the one or more packets into the first format for communication over the wired connection by using a reception process for processing the one or more packets into the first format. The transmitting node 150 may select the reception process out of a number of reception processes configured at the transmitting node 150. The transmitting node 150 may select the reception process based on the indication tagged to the received one or more packets. Alternatively, or additionally, the one or more packets may belong to a flow of packets and may comprise the flow identity identifying the flow. The reception process used on the one or more packets may be selected based on the flow identity. The transmitting node 150 may dynamically select different or respective reception processes for different flows of packets. The transmitting node 150 may further be configured with the preconfigured table associating reception processes with different flow identities or indications tagged to the one or more packets. Thus, the transmitting node 150 may receive a packet tagged with a tag value, and the transmitting node 150 may look-up in the preconfigured table the process to handle the packet using the tag value. Alternatively, the reception process used is preconfigured to be used at the transmitting node 150.

The transmitting node 150 may process the one or more packet by performing one or more of the following: decompressing the one or more packets; decrypting the one or more packets, receiving number of repetitive transmissions of the one or more packets and time adjusting the one or more packets. Time adjusting herein meaning receiving the one or more packets in a buffer and outputting the one or more packets according to a time aligned schedule.

Action 406. The transmitting node 150 may transmit the one or more packets in the first format over the wired connection towards the device 10 or the control node 11.

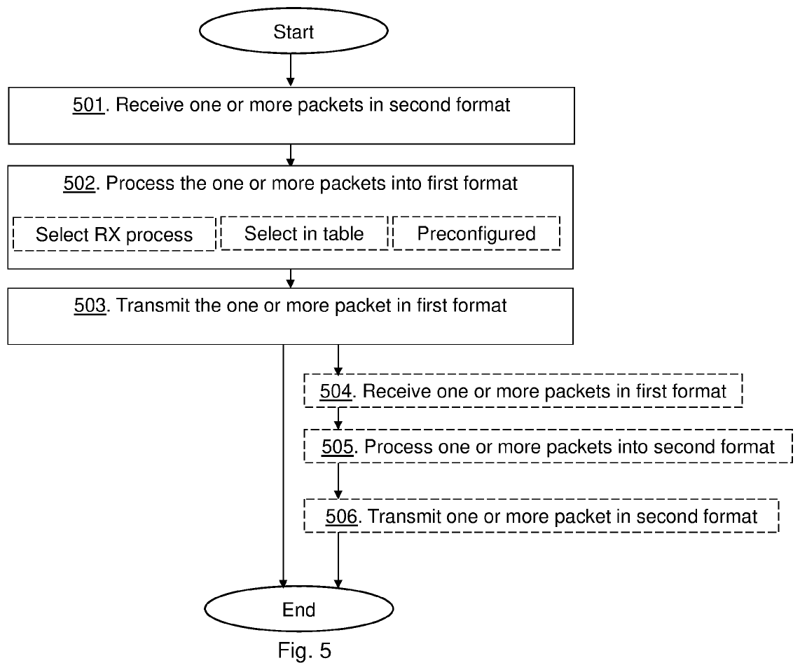

The method actions performed by the receiving node 160, such as the second node 13 or the first node 12, for handling communication between the control node 11 and the device 10 controlled by the control node 11 according to embodiments herein will now be described with reference to a flowchart depicted in FIG. 5. The control node 11 and the device 10 are configured for wired communication in the communication network 1. The receiving node 160 may be a standalone node between a radio access node and the control node 11, or the device 10. The receiving node 160 may additionally or alternatively be a unit collocated with the radio access node, or the control node 11 or the device 10. Optional actions are marked with dashed boxes and the actions may be taken in any suitable order.

Action 501. The receiving node 160 receives the one or more packets in the second format transmitted over the wireless connection from the transmitting node 150. The transmitting node is connected by wire to the control node or the device.

Action 502. The receiving node 160 processes the one or more packets into the first format for communication over the wired connection by using the reception process for processing the one or more packets into the first format. The receiving node 160 may select the reception process out of a number of reception processes configured at the receiving node 160. The receiving node 160 may select the reception process based on the indication tagged to the received one or more packets. Alternatively, or additionally, the one or more packets may belong to a flow of packets and may comprise the flow identity identifying the flow, and wherein the reception process used for processing the one or more packets may be selected based on the flow identity. The receiving node 160 may dynamically select different or respective reception processes for different flows of packets between the control node 11 and the device 10. The receiving node 160 may further be configured with a preconfigured table, second table, associating reception processes with different flow identities or indications tagged to the one or more packets. Thus, the receiving node 160 may receive a packet tagged with a tag value, and the receiving node 160 may look-up in the preconfigured table the process to handle the packet using the tag value. Alternatively, the reception process used is preconfigured to be used at the receiving node.

The reception process used to process the one or more packet may comprises one or more of the following: decompressing the one or more packets; decrypting the one or more packets, receiving number of repetitive transmissions of the one or more packets and time adjusting the one or more packets. Time adjusting herein meaning receiving the one or more packets in a buffer and outputting the one or more packets according to a time aligned schedule.

Action 503. The receiving node 160 transmits the one or more packets in the first format over the wired connection towards the device 10 or the control node 11.

Since the procedure may be reciprocal, with the FATSO entities working in a similar manner on the opposite direction traffic; the receiving node 160 may also perform the following actions.

Action 504. The receiving node 160 may receive one or more packets in the first format from the control node 11 or the device 10 over the wired connection.

Action 505. The receiving node 160 may process the one or more packets into the second format for communication over the wireless connection, by using a transmission process for processing the one or more packets into the second format. For example, the receiving node 160 may select the transmission process out of a number of transmission processes configured at the receiving node 160. The one or more packets may belong to a flow of packets and may comprise the flow identity identifying the flow, and the transmission process used for processing the one or more packets may be selected based on the flow identity. The receiving node 160 may dynamically select different or respective transmission processes for different flows of packets between the control node 11 and the device 10. The transmission process used may be selected from a preconfigured table, the second table, associating transmission processes with different flow identities. It should also be noted that the transmission process used may be preconfigured to be used at the receiving node 160. For example, the receiving node 160 may be preconfigured to compress all packets. The receiving node 160 may further process the one or more packets by tagging the one or more packets with an indication indicating the transmission process used. Thus, the second format may be packets tagged with the indication. For example, the receiving node 160 may tag a value or an index indicating what process has been used on the one or more packets. Thus, this value or index allows identification on which process has been used on a packet on the reception side, which in this case is at the transmitting node 150. The receiving node 160 may process the one or more packets by one or more of the following: compressing the one or more packets, encrypting the one or more packets, and/or adding a number of repetitive transmissions of the one or more packets. The receiving node 160 may further tag one or more packets wherein the tag indicates that the one or more packets may be received with different delays or time differentiated due to the wireless communication and hence a time aligning process may be required at the reception side.

Action 506. The receiving node 160 may transmit the one or more packets in the second format over the wireless connection towards the device 10 or the control node 11.

Thus, it is herein disclosed embodiments where one or more packets may be processed in a number of ways, for example as exemplified below, e.g. removal/compression of ‘spaces’ within packets on any type of flows of packets, even proprietary ones. The transmitting node 150 and the receiving node 160 may carry out different processes on packets of different flows, e.g., compress a first flow of packets, encrypt a second flow of packets, etc. The transmitting node 150 and the receiving node 160 may also carry out a combination of different processes on packets, e.g., compress the first flow of packets, compress-then-encrypt the second flow of packets. In some embodiments the transmitting node 150 and the receiving node 160 may self-communicate the type of process being used on that occasion via the tag values or indications resulting in the transmitting node 150 explicitly informing the receiving node 160 what to do. Embodiments herein may also support alternative more complex topologies such as cascaded daisy-chained, mesh, ring, or star-type configurations, etc. Thus, the control node 11 may transmit/receive flows of packets to one or more devices and the device 10 may transmit/receive flows of packets from one or more control nodes. It should be noted that, a node such as the first node or the second node may host both the transmission process and the reception process, employing one for packets in one direction, and the other for packets in the other direction. It should further be noted that embodiments herein may relate to factory automation communications which is typically timing sensitive and hence, likely require locally connected hardware, e.g., edge cloud or a high-speed link. The tables mentioned herein may be preconfigured, manually entered, stored and retrieved in a cloud environment, or be configured/re-configured from the cloud environment, once or e.g. in an ad-hoc operation. This would have the benefit of having configurations defined at a single point, i.e., in the cloud, which may then be used to set the behavior of the different FATSO entities, potentially with different “preconfigured tables”, located at numerous geographically diverse sites.

It should be noted that transmission process may be a process for adapting the original content of a packet on transmitting side before transmitting the packet over a wireless connection, and after having received it over a wired connection. Alternative term: transmit side transformation process, transmit side conversion process, transmit side content adaptation process. Reception process may be a process for adapting the original content of a packet on receiving side after receiving the packet over a wireless connection, and before sending it on over a wired connection. Alternative term: receive side transformation process, receive side conversion process, receive side content adaptation process.

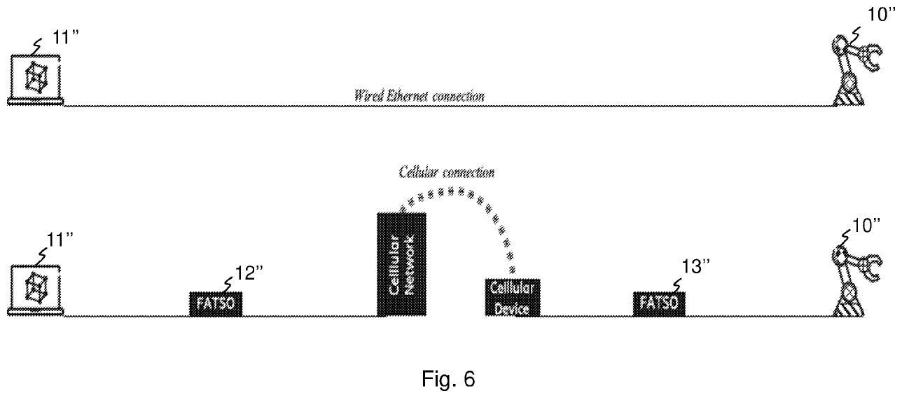

FIG. 6 shows an original factory automation equipment operation over the wired Ethernet link, at the top of FIG. 6, and subsequent migration to the cellular setup, bottom of FIG. 6.

The pair of nodes, marked “FATSO” 12″ and 13″, i.e., examples of the transmitting node 150 and the receiving node 160, receives “sub-optimal” traffic (first format) from the factory automation equipment, modify it into a more optimal form (second format) for wireless transmission, and sends it onward to the cellular system. At the other end, the peer entity receives this information from the cellular system, restores it back to its “sub-optimal” form, and forwards it on to the factory automation machine.

In this way the factory automation equipment, such as a controller 11″ and a robot 10″, operates in the same way as in the wired scenario, while the cellular system transports more optimal (i.e., efficient) traffic over the sensitive wireless link.

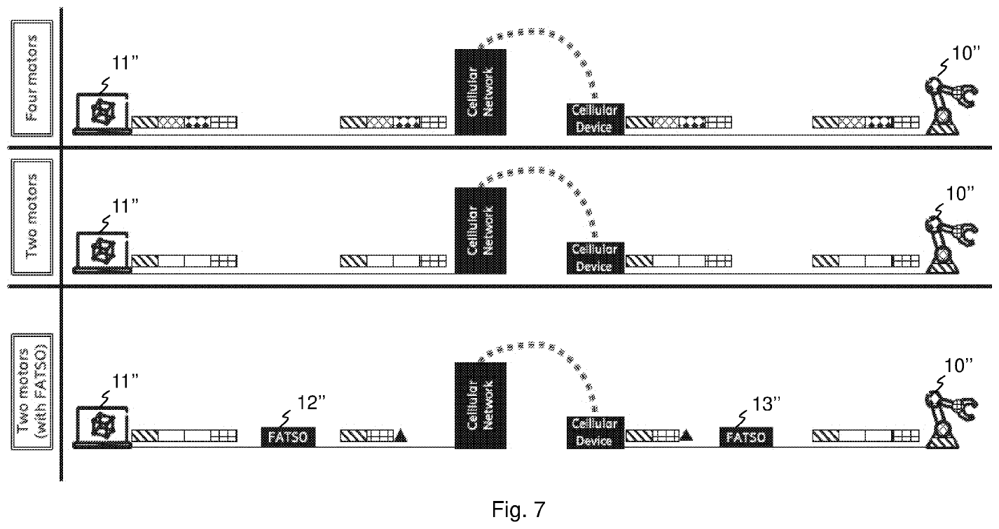

FIG. 7 shows a scenario to optimize frequency spectrum use in a legacy Factory Automation scenario.

A mechanical robot arm (Robot) 10″ consists of 4 independent motors which when operate, result in movement of the Robot 10″. A programmable logic controller (PLC) 11″ sends a stream of packets periodically to the Robot, where each packet comprises of four “sections”, each with information for a particular motor on the Robot. As the continuous stream of packets reach the Robot, the individual motors receive their particular information from the packet and operating independently, result in coordinated motion of the entire Robot 10″.

Thus, FIG. 7 shows a controller on the left sending motor position information, being example of one or more packets, to the robot 10″ on the right. Information is sent out in packets, which are made up of 4 “sections”, each representing one motor's information or instruction. The top part of FIG. 7 shows this communication from the PLC 11″ on the left to the robot 10″ on the right. Each packet transmitted by the PLC 11″ comprises of four “sections”, each with information for a particular motor on the Robot 10″.

The middle part of FIG. 7 depicts a scenario where the robot 10″ is executing a limited movement where only two of the four motors need to operate. A less-efficient implementation of the PLC 11″ would send pattern of packets to the robot 10″, but two “sections” of the packets would be filled with zeroes or (unused) padding information, depicted as white space in packets of the middle part of FIG. 7.

This results in an inefficient amount of radio resources used, where 50% of the capacity consumed by this traffic stream is wasted.

The bottom part of FIG. 7 depicts embodiments herein providing optimization for spectrum or resource capacity of the wireless communication. A first FATSO entity 12″ is placed on the path between the PLC 11″ and the cellular network and a peer or second FATSO entity 13″ is placed on the path between the cellular network and the robot 10″.

The first FATSO entity 12″ on the left may be instructed to remove the zero/padding/unused “sections” of the received packets from the left, creating a smaller packet, and tagging these packets, with a black triangle, and sending these smaller sized packets onward to the cellular network.

On the other end of the cellular network, the second FATSO entity 13″ receives a packet from the cellular network, notices the tag (i.e., black triangle), recreates the original packet comprising of the two padding “segments”, and forwards this recreated packet onward to the robot 10″.

In this way the PLC 11″ and robot 10″ operate unchanged, while the packet stream is “massaged” or altered into a more optimal form for transmission over the cellular link, thereby saving 50% of the valuable radio capacity.

The solution could be reciprocal, with the FATSO entities working in a similar manner on the opposite direction traffic.

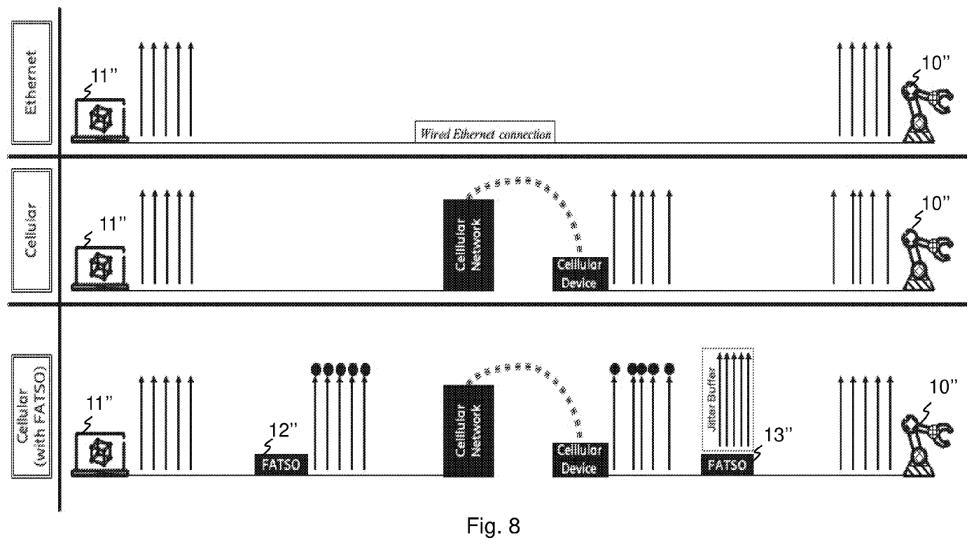

FIG. 8 depicts a scenario that expands on the earlier scenario described above. The PLC 11″ on the left sends a stream of packets to the robot 10″ on the right. However, embodiments herein consider timings of the packets being transmitted at the first FATSO entity 12″ and received at the second FATSO entity 13″, for example, timing of the packets transmitted between the PLC 11″ on the left and the robot 10″ on the right, under different conditions.

The top section of FIG. 8 shows the timings of the packet stream from the PLC 11″ to the robot 10″ when operating over the conventional wired Ethernet connection. The timings between the individual packets are constant, both at the PLC 11″ and the robot 10″.

The middle part of FIG. 8 shows the packets going through the cellular system. Because of the nature of wireless cellular communications, the times for the individual packets to traverse the wireless link varies, resulting in varying inter-packet times, i.e., time between packets, or “jitter” at the receiving robot 10″. This jitter may result in inefficient operation or potentially, even complete malfunction of the Robot 10″, and should be avoided.

According to embodiments herein, depicted at the bottom of FIG. 8, this is solved by implementing the two FATSO entities. Thus, the FATSO entities are placed on the “left” and on the “right” as before. As packets from the PLC 11″ arrive at the left FATSO device 12″, these are marked with a circle and sent to the cellular system. When the peer FATSO device 13″ on the right receives these marked or tagged packets from the cellular system, it understands that these packets need to be un-tagged and placed in a jitter buffer, a mechanism used to remove the jitter in the flow at the output of the wireless receiver, i.e., when the packets go back to the wired/copper communication system, whereby they will be subsequently released in a periodic manner onward to the robot 10″. Thus, the jitter buffer collects the marked packets and outputs the packets according to a configured time periodicity, i.e., time aligned, reducing time fluctuations between the packets. For example, transmitted at preconfigured transmission times.

From the legacy wired communication characteristics it is know at what time instances the packets should arrive and immediately be sent onwards at the receiver side. This is included in the configuration of the FATSO pair. If packets arrive early or late at the receiver, the packets are put in a first in first out (FIFO) buffer and sent onwards without any jitter, i.e., with exactly the same time interval between them. This introduces an overall delay in the communication but removes the jitter.

The resulting effect to the factory automation equipment is that the traffic they generate, and receive, both appear to operate in a wired Ethernet system. As stated above, the solution may be reciprocal, with the FATSO entities working in a similar manner on the opposite direction traffic.

The examples above in FIGS. 7 and 8 provide simplified scenarios to more easily illustrate embodiments herein. It should be noted that these examples may easily be taken to the “next step” and be extended into more relatable real-world.

For example, in FIG. 7, it is shown that the ‘blank portions’ of the original packet are omitted during over-the-air transmission by the first FATSO entity. Additionally, one could also further reduce the size of the shaded portions being transmitted, e.g., via compression mechanisms at the source FATSO entity to further optimize over-the-air wireless transmissions, with the receiving FATSO entity executing a corresponding decompression step before inserting the padding bits to restore the received transmission back into its original form.

FIG. 8 shows a jitter buffer implemented at the receiving FATSO entity. Again, it would be possible to carry out inspection and analysis of the received packet stream and potentially extrapolate values from a sequence of packets to predict and recreate any missing packets lost in the stream, with error-concealment techniques, thereby increasing performance of the communication.

In general, the FATSO infrastructure opens up the possibility of numerous new ways of processing packets, like compression, encryption, repetition for reliability, etc., to enhance the quality of the communications between the control node and the device.

In the examples described above, the FATSO entities are operated on the “sub-optimal” flow of packets, and made it more efficient, firstly for transmission over the wireless cellular network in FIG. 7, and secondly, for operation of the robot 10″ in FIG. 8. Thus, embodiments herein enable the first FATSO entity 12″ and the second FATSO entity 13″ to understand what process to use on the packets they receive.

The FATSO entities may be pre/re-configured with a priori information on the type of traffic which they may receive from the robot 10″ or the PLC 11″. This configuration may be achieved by numerous techniques, ranging from simple manual typing of instructions into the respective FATSO entity, to downloading binary content via static memory devices such as floppy discs or “memory sticks”, to remotely downloading configuration via a control channel from a remote server/source to the respective FATSO entity over the network. A table may be created and used which maps the type of traffic to be received, to the process to carry out on these packets, and the tag to be used for this traffic.

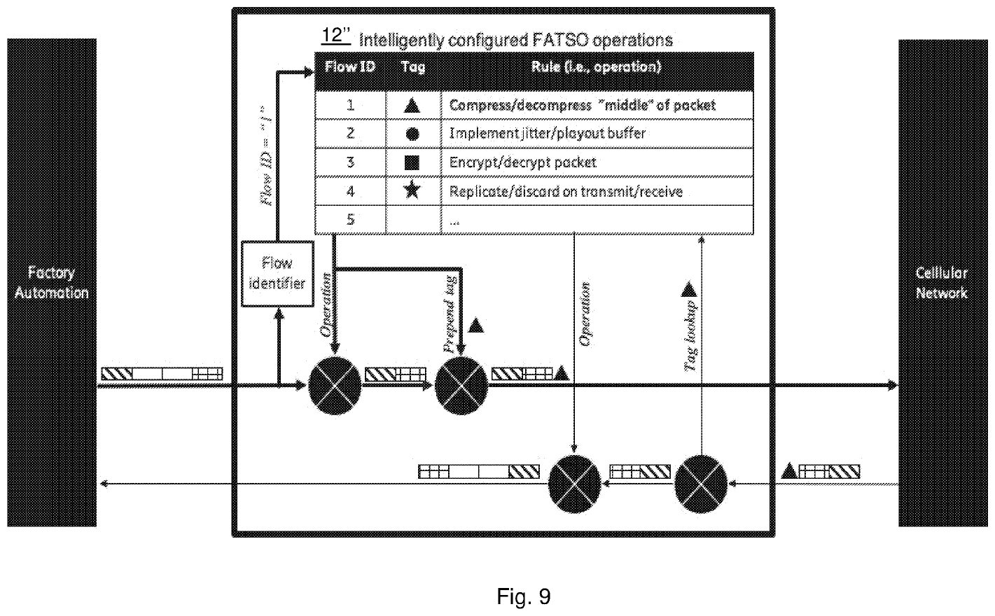

FIG. 9 shows one possible logical embodiment of the first node 12, for example, the first FATSO entity 12″. The first FATSO entity 12″ may be pre-configured with a table indicating flows of packets which may be received (Flow ID), the marking or tag to be used on these packets, and the process to be executed on these packets. FIG. 9 depicts the operation for the “compression” example given in FIG. 7.

The first FATSO entity 12″ receives “Sub-optimal” packets, packets in the first format, from the PLC 11″, which are identified by a flow identifier and assigned a Flow ID. This identification process may comprise inspecting the packets by the packet header or by some other method that is adopted to the communication protocol used in the legacy wired communication. The flow ID may then be referred to in the table. From here the packets are operated upon, such as the middle of the packets are compressed or removed and marked with a tag before being transmitted over the wireless connection.

It should be noted that other packets, for example, from the robot 10″, may be received over the wireless connection and may arrive with a tag. The first FATSO entity 12″ may then look up from the table the process to use based on the tag, and the first FATSO entity 12″ may then process the packets before transmission out to the PLC 11″.

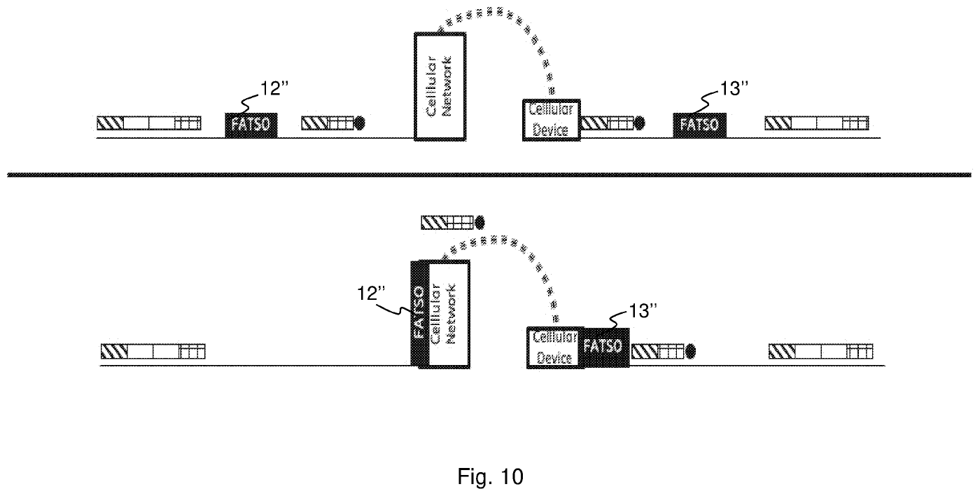

As illustrated in FIG. 10, the first FATSO entity 12″ and the second FATSO entity 13″ may be realized in hardware as a physical device, see FIG. 10 top view, or as a piece of software which may be incorporated in existing hardware such as a node in the cellular network and the mobile device, see FIG. 10 bottom view, or possibly a combination of the above.

FIG. 11 is a block diagram depicting the transmitting node 150 for handling communication between the control node 11 and the device 10 controlled by the control node 11 according to embodiments herein. The control node 11 and the device 10 are configured for wired communication. The transmitting node may be a standalone node between a radio access node and the control node, or the device; or a unit collocated with the radio access node, or the control node or the device.

The transmitting node 150 may comprise processing circuitry 1101, e.g. one or more processors, configured to perform the methods herein.

The transmitting node 150 may comprise a receiving unit 1102, e.g. a receiver or a transceiver. The transmitting node 150, the processing circuitry 1101 and/or the receiving unit 1102 is configured to receive the one or more packets in the first format from the control node or the device over the wired connection,

The transmitting node 150 may comprise a processing unit 1103, such as a compressing unit, encoder, or similar. The transmitting node 150, the processing circuitry 1101 and/or the processing unit 1103 is configured to process the one or more packets into the second format for communication over the wireless connection comprising using the transmission process for processing the one or more packets into the second format. The transmitting node 150, the processing circuitry 1101 and/or the processing unit 1103 may be configured to process the one or more packets by selecting the transmission process out of a number of transmission processes configured at the transmitting node. The one or more packets may belong to a flow of packets and comprise the flow identity identifying the flow, and the transmitting node, the processing circuitry 1101 and/or the processing unit 1103 may be configured to select the transmission process used for processing the one or more packets based on the flow identity. The transmitting node 150, the processing circuitry 1101 and/or the processing unit 1103 may be configured to select the transmission process by dynamically selecting different or respective transmission processes for different flows of packets between the control node and the device. The transmitting node 150, the processing circuitry 1101 and/or the processing unit 1103 may be configured to select the transmission process from the preconfigured table comprising associating transmission processes with different flow identities. The transmitting node 150, the processing circuitry 1101 and/or the processing unit 1103 may be preconfigured to use the transmission process at the transmitting node 150, i.e. the transmission process may be “fixed”, not variable. For example, the transmitting node 150, the processing circuitry 1101 and/or the processing unit 1103 may be configured to process all packets with one preconfigured process. The transmitting node 150, the processing circuitry 1101 and/or the processing unit 1103 may be configured to tag the one or more packets with the indication indicating the transmission process used. The transmission process used for processing the one or more packets may comprise one or more of the following: compressing the one or more packets, encrypting the one or more packets, and/or adding a number of repetitive transmissions of the one or more packets. The packets of the second format may thus be compressed packets, encrypted packets, repetitive transmitted packets, or just packets of the first format tagged with the indication indicating a process to be used at the reception side such as time adjusting. Time adjusting herein meaning receiving the one or more packets in a buffer and outputting the one or more packets according to a time aligned schedule.

The transmitting node 150 may comprise a transmitting unit 1104, e.g. a transmitter or a transceiver. The transmitting node 150, the processing circuitry 1101 and/or the transmitting unit 1104 is configured to transmit the one or more packets in the second format over the wireless connection towards the device 10 or the control node 11.

The transmitting node 150 may further comprise a memory 1105. The memory 1105 comprises one or more units to be used to store data on, such as indications, processes, tables, packets, configuration, reconfiguration, tag values, scheduling information, applications to perform the methods disclosed herein when being executed, and similar. The transmitting node 150 comprises a communication interface 1108 comprising transmitter, receiver, transceiver and/or one or more antennas. Thus, it is herein provided the transmitting node 150 for handling communication in a wireless communication network, wherein the transmitting node 150 comprises processing circuitry and a memory, said memory comprising instructions executable by said processing circuitry whereby said transmitting node 150 is operative to perform any of the methods disclosed herein.

The methods according to the embodiments described herein for the transmitting node 150 may respectively be implemented by means of e.g. a computer program product 1106, comprising instructions, i.e., software code portions, which, when executed on at least one processor, cause the at least one processor to carry out the actions described herein, as performed by the transmitting node 150. The computer program product 1106 may be stored on a computer-readable storage medium 1107, e.g. a universal serial bus (USB) stick, a disc or similar. The computer-readable storage medium 1107, having stored thereon the computer program product, may comprise the instructions which, when executed on at least one processor, cause the at least one processor to carry out the actions described herein, as performed by the transmitting node 150. In some embodiments, the computer-readable storage medium may be a non-transitory or transitory computer-readable storage medium.

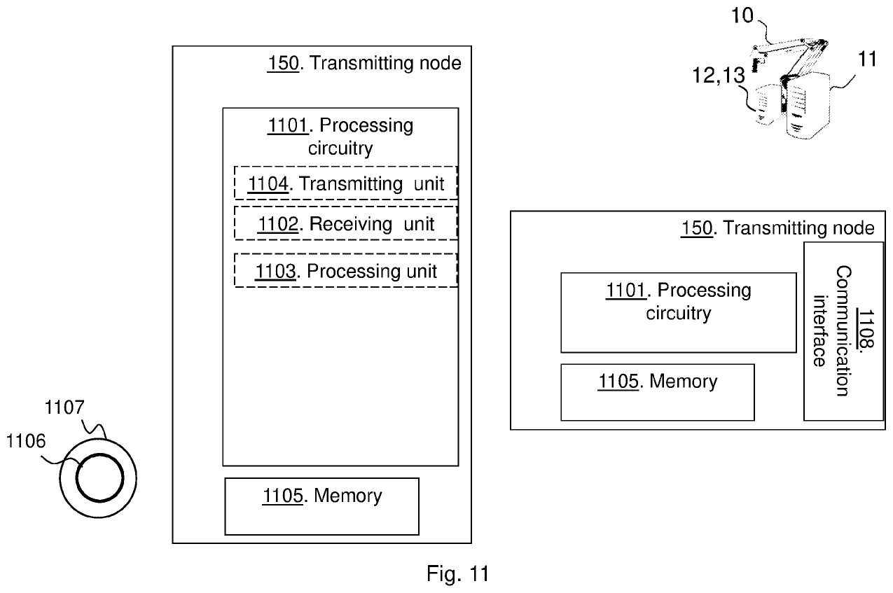

FIG. 12 is a block diagram depicting the receiving node 160 for handling communication between the control node 11 and the device 10 controlled by the control node 11 according to embodiments herein. The control node 11 and the device 10 are configured for wired communication. The receiving node may be a standalone node between a radio access node and the control node, or the device; or a unit collocated with the radio access node, or the control node or the device.

The receiving node 160 may comprise processing circuitry 1201, e.g. one or more processors, configured to perform the methods herein.

The receiving node 160 may comprise a receiving unit 1202, e.g. a receiver or a transceiver. The receiving node 160, the processing circuitry 1201 and/or the receiving unit 1202 is configured to receive the one or more packets in the second format transmitted over the wireless connection from the transmitting node, wherein the transmitting node is connected by wire to the control node or the device.

The receiving node 160 may comprise a processing unit 1203, such as a decompressing unit, decoder, or similar. The receiving node 160, the processing circuitry 1201 and/or the processing unit 1203 is configured to process the one or more packets into the first format for communication over the wired connection using the reception process for processing the one or more packets into the first format. The receiving node 160, the processing circuitry 1201 and/or the processing unit 1203 may be configured to process the one or more packets by selecting the reception process out of a number of reception processes configured at the receiving node. The one or more packets may belong to a flow of packets and comprises the flow identity identifying the flow, and the receiving node 160, the processing circuitry 1201 and/or the processing unit 1203 may be configured to select the reception process used for processing the one or more packets based on the flow identity. The receiving node 160, the processing circuitry 1201 and/or the processing unit 1203 may be configured to select the reception process based on the indication tagged to the received one or more packets. The receiving node 160, the processing circuitry 1201 and/or the processing unit 1203 may be configured to dynamically select different or respective reception processes for different flows of packets between the control node and the device. The receiving node 160, the processing circuitry 1201 and/or the processing unit 1203 may be configured to select the reception process from the preconfigured table associating reception processes with different flow identities or indications tagged to the one or more packets. The reception process used for processing the one or more packets may be preconfigured to be used at the receiving node 160, i.e. the reception process may be “fixed”, not variable. The reception process used to process the one or more packets may comprise one or more of the following: decompressing the one or more packets, decrypting the one or more packets, or receiving number of repetitive transmissions of the one or more packets and/or time adjusting the one or more packets.

The receiving node 160 may comprise a transmitting unit 1204, e.g. a transmitter or a transceiver. The receiving node 160, the processing circuitry 1201 and/or the transmitting unit 1204 is configured to transmit the one or more packets in the first format over the wired connection towards the device or the control node.

The receiving node 160 may further comprise a memory 1205. The memory 1205 comprises one or more units to be used to store data on, such as indications, processes, tables, packets, configuration, reconfiguration, tag values, scheduling information, applications to perform the methods disclosed herein when being executed, and similar. The receiving node 160 comprises a communication interface 1208 comprising transmitter, receiver, transceiver and/or one or more antennas. Thus, it is herein provided the receiving node 160 for handling communication in a wireless communication network, wherein the receiving node 160 comprises processing circuitry and a memory, said memory comprising instructions executable by said processing circuitry whereby said receiving node 160 is operative to perform any of the methods disclosed herein.

The methods according to the embodiments described herein for the receiving node 160 are respectively implemented by means of e.g. a computer program product 1206, comprising instructions, i.e., software code portions, which, when executed on at least one processor, cause the at least one processor to carry out the actions described herein, as performed by the receiving node 160. The computer program product 1206 may be stored on a computer-readable storage medium 1207, e.g. a universal serial bus (USB) stick, a disc or similar. The computer-readable storage medium 1207, having stored thereon the computer program product, may comprise the instructions which, when executed on at least one processor, cause the at least one processor to carry out the actions described herein, as performed by the receiving node 160. In some embodiments, the computer-readable storage medium may be a non-transitory or transitory computer-readable storage medium.

As will be readily understood by those familiar with communications design, functions, means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communication devices will appreciate the cost, performance, and maintenance trade-offs inherent in these design choices.

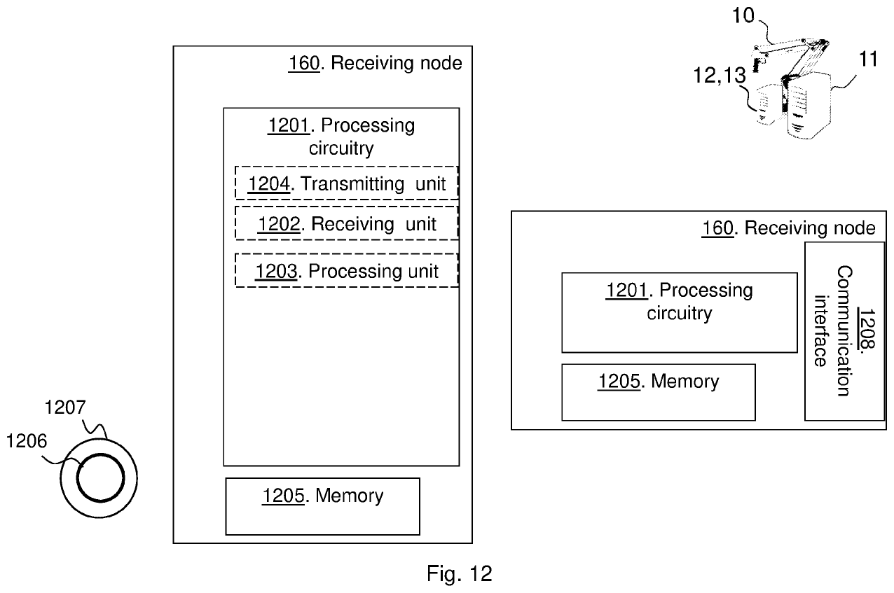

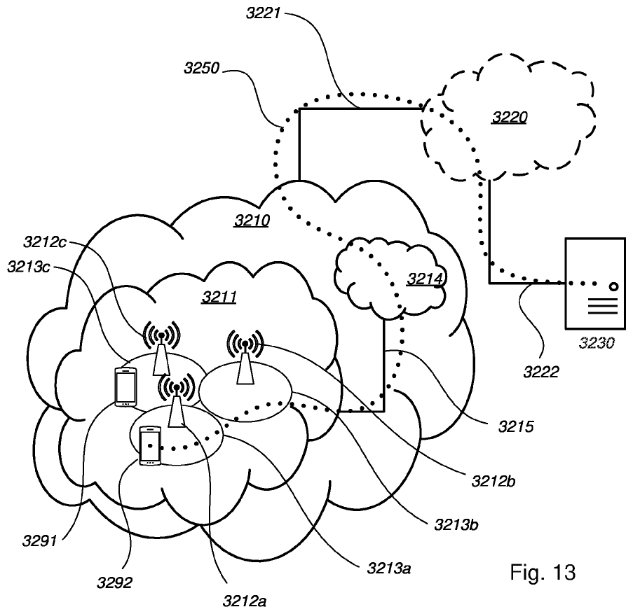

With reference to FIG. 13, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 13 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

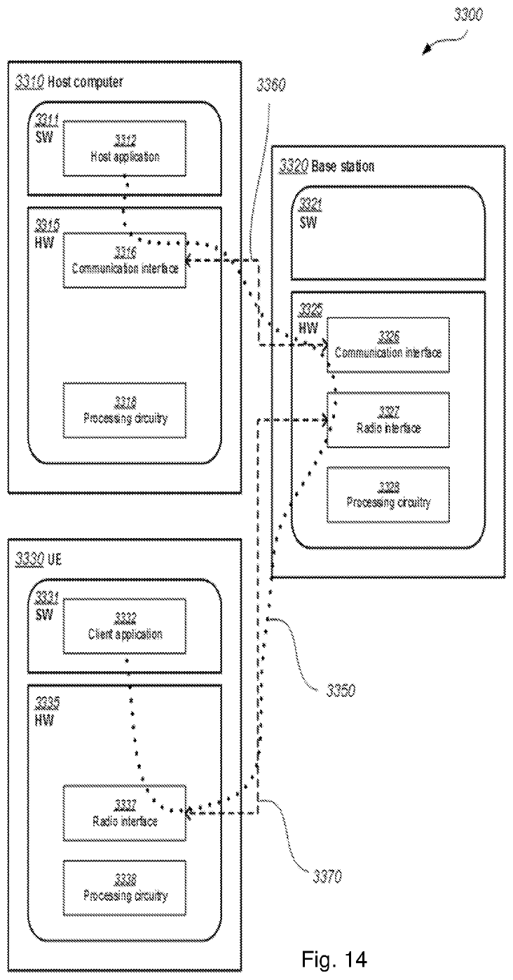

Example implementations, in accordance with an embodiment, of the UE, base station and host computer discussed in the preceding paragraphs will now be described with reference to FIG. 14. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 14) served by the base station 3320. The communication interface 3326 may be configured to facilitate a connection 3360 to the host computer 3310. The connection 3360 may be direct or it may pass through a core network (not shown in FIG. 14) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 14 may be identical to the host computer 3230, one of the base stations 3212a, 3212b, 3212c and one of the UEs 3291, 3292 of FIG. 13, respectively. This is to say, the inner workings of these entities may be as shown in FIG. 14 and independently, the surrounding network topology may be that of FIG. 13.

In FIG. 14, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may achieve both high reliability and performance using wireless connection in a system for wired communication and thereby provide benefits such as improved battery time, mobility and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

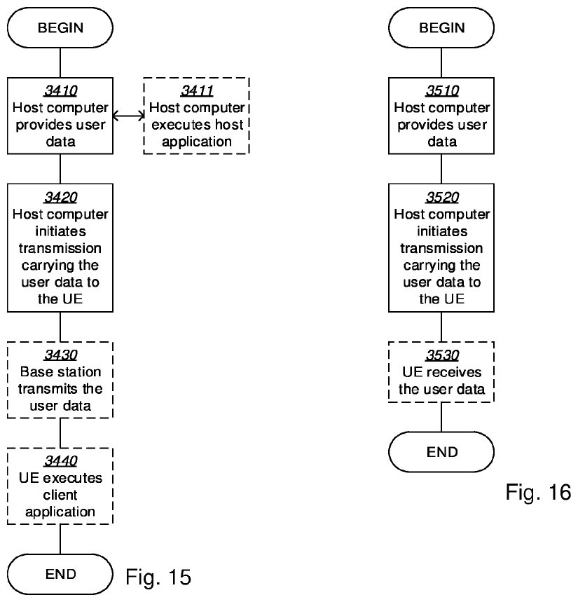

FIG. 15 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 15 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 16 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 16 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

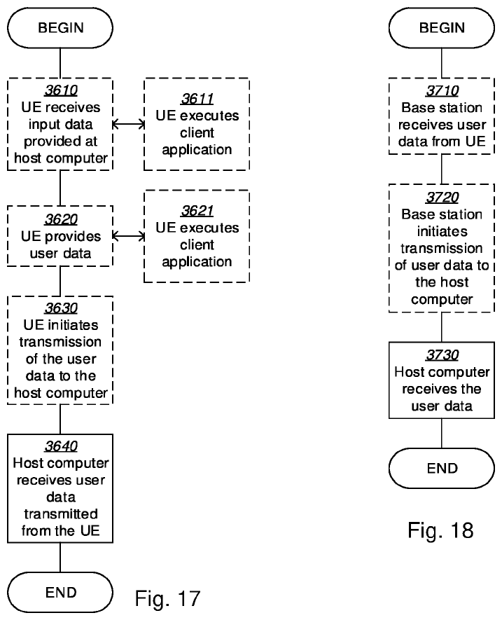

FIG. 17 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 17 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 18 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 18 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1. A method performed by a transmitting node for handling communication between a control node and a device controlled by the control node, the control node and the device being configured for wired communication, the method comprising:
receiving one or more packets in a first format from the control node or the device over a wired connection;
processing the one or more packets into a second format for communication over a wireless connection, the processing comprising using a transmission process for processing the one or more packets into the second format; and
transmitting the one or more packets in the second format over the wireless connection towards the device or the control node.

2. The method according to claim 1, wherein processing the one or more packets comprises selecting the transmission process out of a number of transmission processes configured at the transmitting node.

3. The method according to claim 2, wherein the one or more packets belong to a flow of packets, and comprise a flow identity identifying the flow, and wherein the transmission process used for processing the one or more packets is selected based on the flow identity.

4. The method according to claim 2, wherein selecting the transmission process comprises dynamically selecting respective transmission processes for different flows of packets between the control node and the device.

5. The method according to claim 2, wherein the transmission process used for processing the one or more packets is selected from a preconfigured table comprising one or more indications associating transmission processes with different flow identities.

6. The method according to claim 1, wherein the transmission process used for processing the one or more packets is preconfigured to be used at the transmitting node.

7. The method according to claim 1, wherein processing the one or more packets comprises tagging the one or more packets with an indication indicating the transmission process used for processing the one or more packets.

8. The method according to claim 1, wherein the transmission process used for processing the one or more packets comprises one or more of the following: compressing the one or more packets, encrypting the one or more packets, and/or adding a number of repetitive transmissions of the one or more packets.

9. The method according to claim 1, wherein the transmitting node is a standalone node between a radio access node and the control node, or the device; or a unit collocated with the radio access node, or the control node or the device.

10. A method performed by a receiving node for handling communication between a control node and a device controlled by the control node, the control node and the device being configured for wired communication, the method comprising:
receiving one or more packets in a second format transmitted over a wireless connection from a transmitting node, the transmitting node being connected by wire to the control node or the device;
processing the one or more packets into a first format for communication over a wired connection, the processing comprising using a reception process for processing the one or more packets into the first format; and
transmitting the one or more packets in the first format over the wired connection towards the device or the control node.

11. The method according to claim 10, wherein processing the one or more packets comprises selecting the reception process out of a number of reception processes configured at the receiving node.

12. The method according to claim 11, wherein the one or more packets belong to a flow of packets, and comprise a flow identity identifying the flow, and wherein the reception process used for processing the one or more packets is selected based on the flow identity.

13. The method according to claim 11, wherein selecting the reception process is based on an indication tagged to the received one or more packets.

14. The method according to claim 11, wherein selecting the reception process comprises dynamically selecting respective reception processes for different flows of packets between the control node and the device.

15. The method according to claim 11, wherein the reception process is selected from a preconfigured table associating reception processes with different flow identities or indications tagged to the one or more packets.

16. The method according to claim 10, wherein the reception process used for processing the one or more packets is preconfigured to be used at the receiving node.

17. The method according to claim 10, wherein the reception process used for processing the one or more packets comprises one or more of the following: decompressing the one or more packets, decrypting the one or more packets, or receiving number of repetitive transmissions of the one or more packets and/or time adjusting the one or more packets.

18. The method according to claim 10, wherein the receiving node is a standalone node between a radio access node and the control node, or the device; or a unit collocated with the radio access node, or the control node or the device.

19. A transmitting node for handling communication between a control node and a device controlled by the control node, the control node and the device being configured for wired communication, and the transmitting node being configured to:
receive one or more packets in a first format from the control node or the device over a wired connection;
process the one or more packets into a second format for communication over a wireless connection, the process comprising using a transmission process for processing the one or more packets into the second format; and
transmit the one or more packets in the second format over the wireless connection towards the device or the control node.

20.-27. (canceled)

28. A receiving node for handling communication between a control node and a device controlled by the control node, the control node and the device being configured for wired communication, and the receiving node being configured to:
receive one or more packets in a second format transmitted over a wireless connection from a transmitting node, the transmitting node being connected by wire to the control node or the device;
process the one or more packets into a first format for communication over a wired connection, the process comprising using a reception process for processing the one or more packets into the first format; and
transmit the one or more packets in the first format over the wired connection towards the device or the control node.

29. The receiving node according to claim 28, wherein the receiving node is configured to process the one or more packets by selecting the reception process out of a number of reception processes configured at the receiving node.

30.-38. (canceled)
